(19) United States
(12) Patent Application Publication
(10) Pub. No.: US 2019/0369867 A1
(43) Pub. Date: Dec. 5, 2019

(54) DISPLAY APPARATUS, DISPLAY CONTROL METHOD, AND NON-TRANSITORY COMPUTER-READABLE STORAGE MEDIUM FOR STORING PROGRAM

(71) Applicant: HONDA MOTOR CO., LTD., Tokyo (JP)

(72) Inventor: Tatsuya AKIMARU, Wako-shi (JP)

(21) Appl. No.: 16/418,172

(22) Filed: May 21, 2019

(30) Foreign Application Priority Data
Jun. 4, 2018 (JP) 2018-107127

(51) Int. Cl. G06F 3/0488; G06F 3/0482; G06F 3/044; G06F 3/041

(52) U.S. Cl. CPC G06F 3/04886; G06F 3/0482; G01C 21/3664; G06F 3/0416; G06F 3/044

(57) ABSTRACT

A display apparatus comprises a display unit configured to display screen data containing a plurality of selectable items; and a display control unit configured to change the screen data in accordance with selection of an item contained in the screen data, when a touch operation is performed on a display surface of the display unit. During a course of the touch operation, the display control unit changes the screen data in accordance with a position of a conductive object in a space on the display surface, which corresponds to an item.

### CROSS-REFERENCE TO RELATED APPLICATION(S)

This application claims priority to and the benefit of Japanese Patent Application No. 2018-107127 filed on Jun. 4, 2018, the entire disclosure of which is incorporated herein by reference.

### BACKGROUND OF THE INVENTION

### Field of the Invention

The present invention relates to a display apparatus having a touch panel, a display control method, and a non-transitory computer-readable storage medium for storing a program.

### Description of the Related Art

Display apparatuses to be mounted in vehicles are providing various user interface screens such as a navigation screen and a setting screen, and more and more required to improve the operability for passengers of vehicles. To meet this demand, many display apparatuses have a display screen that facilitates an intuitive operation by a passenger of a vehicle.

Japanese Patent Laid-Open No. 2004-70829 describes that a rectangular frame such as a picture frame is formed by connecting wide straight lines, frames equal in number to layers are arranged on the screen from the front to the back, and the center of the screen is expressed as a vanishing point by using the one-point perspective method. Japanese Patent Laid-Open No. 2004-70829 also describes that when the user selects a menu item in a configuration like this, the frames are enlarged and reduced in number so as to display a frame in the back of a front frame as if the back frame has moved to the front, so the user can instinctively recognize the depth of layers from the number of displayed frames.

Japanese Patent Laid-Open No. 2012-51398 describes that in a configuration in which a touch pad surface and a display screen are perpendicular to each other, a virtual three-dimensional space in which a plurality of icon attached screens 21a, 21b, and 21c are arranged from the front to the back is displayed. Japanese Patent Laid-Open No. 2012-51398 also describes that in a configuration like this, the user can move all the icon attached screens 21a, 21b, and 21c forward and backward by designating a front-back movement on the touch panel by using two or more fingers.

Japanese Patent Laid-Open No. 2016-9300 describes that a display apparatus is mounted in a position above the instrument panel and before the center console, and a detection unit is arranged on the side of a space between the display apparatus and a passenger in the driver's seat. Japanese Patent Laid-Open No. 2016-9300 also describes that in a configuration like this, when the driver extends a finger into the space between the display apparatus and the driver's seat and moves the finger toward the display apparatus, the detection unit detects this, so the driver can perform an intuitive input operation on the display apparatus even from a position apart from the display apparatus. Japanese Patent Laid-Open No. 2016-9300 further describes that the driver selects one of a plurality of icon images vertically arranged in the form of an arc by performing an aerial operation by which the driver vertically moves the fingertip extended toward the display apparatus, and decides the selected input by moving the fingertip to the left and closer to the detection unit.

A screen such as a setting screen often includes a plurality of layers of menu screens. When the user selects an item on a given menu screen, a next menu screen corresponding to the selection is displayed. When a display apparatus that displays a setting screen like this is mounted in, for example, a vehicle in which an operator must perform an operation, such as driving, other than an operation on the display apparatus, it is desirable to perform transition of the menu screens between the plurality of layers by a simple operation. However, none of Japanese Patent Laid-Open Nos. 2004-70829, 2012-51398, and 2016-9300 describes a configuration capable of a simple setting operation including item selection in transition between screens.

### SUMMARY OF THE INVENTION

The present invention provides a display apparatus capable of a simple setting operation in transition between screens, a display control method, and a non-transitory computer-readable storage medium for storing a program.

The present invention in its first aspect provides a display apparatus comprising: a display unit configured to display screen data containing a plurality of selectable items; and a display control unit configured to change the screen data in accordance with selection of an item contained in the screen data, when a touch operation is performed on a display surface of the display unit, wherein during a course of the touch operation, the display control unit changes the screen data in accordance with a position of a conductive object in a space on the display surface, which corresponds to an item.

The present invention in its second aspect provides a display control method to be executed in a display apparatus, comprising: displaying screen data containing a plurality of selectable items on a display unit; changing the screen data in accordance with selection of an item contained in the screen data, when a touch operation is performed on a display surface of the display unit, and changing the screen data in accordance with a position of a conductive object in a space on the display surface, which corresponds to an item, during a course of the touch operation.

The present invention in its third aspect provides a non-transitory computer-readable storage medium storing a program for causing a computer to perform: displaying screen data containing a plurality of selectable items on a display unit; changing the screen data in accordance with selection of an item contained in the screen data, when a touch operation is performed on a display surface of the display unit, and changing the screen data in accordance with a position of a conductive object in a space on the display surface, which corresponds to an item, during a course of the touch operation.

The present invention makes it possible to perform a simple setting operation in transition between screens.

### BRIEF DESCRIPTION OF THE DRAWINGS

FIG. 1 is a view showing the way a display apparatus is mounted in a vehicle;

FIG. 2 is a view showing the internal configuration of the display apparatus;

FIG. 3 is a flowchart showing a process of shifting to a one-touch setting mode;

FIG. 4 is a flowchart showing a screen transition process corresponding to the approach of a finger;

FIG. 5 is a flowchart showing a finger locus information obtaining process;

FIG. 6 is a flowchart showing a determination process pertaining to a region;

FIG. 7 is a flowchart showing a screen deciding process;

FIG. 8 is a view for explaining the one-touch setting mode;

FIG. 9 is a view for explaining the one-touch setting mode;

FIG. 10 is a view for explaining the one-touch setting mode;

FIG. 11 is a flowchart showing a screen data generation process;

FIG. 12 is a view showing a screen on which the layout of selection items is optimized;

FIGS. 13A, 13B, and 13C are views for explaining the optimization of the layout of the selection items; and

FIG. 14 is a flowchart showing a region adjusting process.

### DESCRIPTION OF THE EMBODIMENT

An embodiment will be explained in detail below with reference to the accompanying drawings. Note that the following embodiment does not restrict the invention according to the scope of claims, and not all combinations of features explained in the embodiment are necessarily essential to the invention. Two or more features of a plurality of features explained in the embodiment can freely be combined. Note also that the same reference numerals denote the same or similar parts, and a repetitive explanation thereof will be omitted.

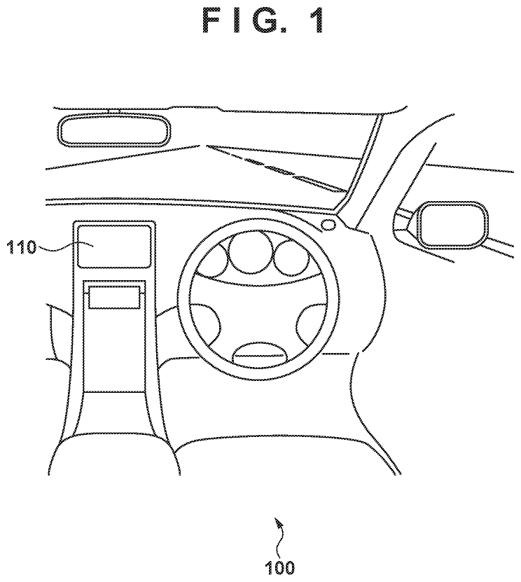

FIG. 1 is a view showing the way a display apparatus of this embodiment is mounted in a vehicle. As shown in FIG. 1, a display apparatus 110 is installed in an almost central portion of an instrument panel in the cabin of a vehicle 100. However, the installation position of the display apparatus 110 is not limited to the portion shown in FIG. 1. For example, the display apparatus 110 may also be installed in a position facing a front passenger's seat or in a position facing a rear seat.

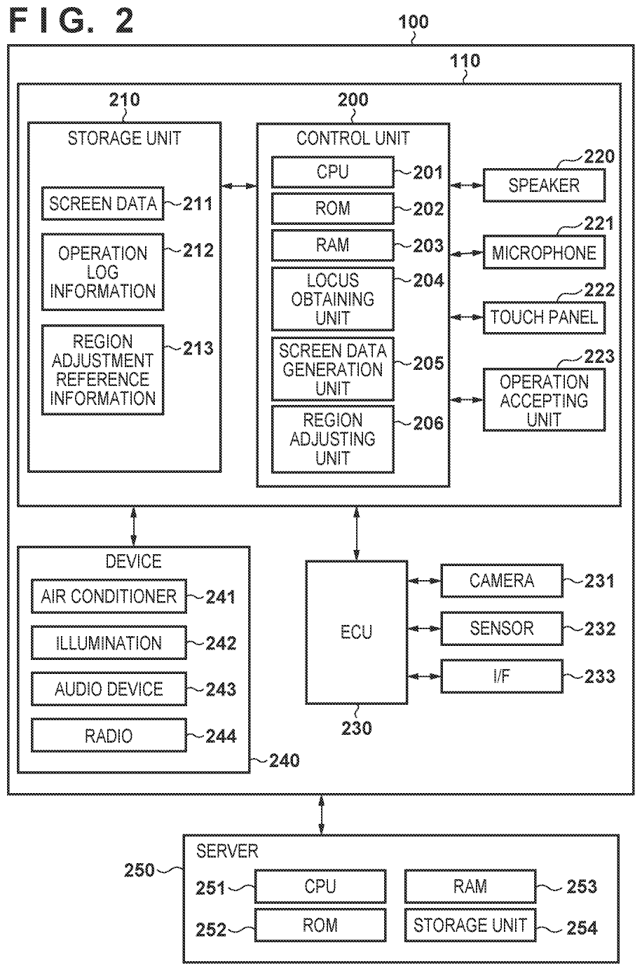

FIG. 2 is a view showing the internal configuration of the display apparatus 110. As shown in FIG. 2, the display apparatus 110 includes a control unit 200, a storage unit 210, a speaker 220, a microphone 221, a touch panel 222, and an operation accepting unit 223. The control unit 200 comprehensively controls the whole display apparatus 110, and can also communicate with an ECU (Electronic Control Unit) 230.

In the control unit 200, individual blocks are connected via a bus, and a CPU 201 controls each block connected to the bus. A ROM 202 stores a basic control program and parameters for operating the control unit 200. The operation of the display apparatus 110 as explained in this embodiment is implemented by the CPU 201 by loading the control program and parameters into a RAM 203 and executing them. The display apparatus 110 can also be a computer for carrying out the present invention according to the program. The ROM 202 stores locus information obtained from the touch panel 222 by a locus obtaining unit 204.

The locus obtaining unit 204 obtains, from the touch panel 222, the locus information indicating the locus of the finger of a passenger on the touch panel 222. A screen data generation unit 205 generates screen data to be displayed on the touch panel 222, based on operation log information 212 (to be described later). A region adjusting unit 206 adjusts a detection region for detecting the finger on the touch panel 222, based on user attribute information obtained from the ECU 230. The user attribute information will be described later.

The storage unit 210 is a hard disk or the like, and stores screen data 211, the operation log information 212, and region adjustment reference information 213. The screen data 211 is, for example, the setting screen of each device 240 mounted in the cabin of the vehicle 100, and contains screen data of a plurality of layers. The operation log information 212 is log information about an operation indicating a setting item selected on the touch panel 222 by the user of the display apparatus 110. In this embodiment, the user is a passenger in the cabin of the vehicle 100. The region adjustment reference information 213 contains reference information with which the region adjusting unit 206 adjusts the detection region for detecting the finger on the touch panel 222.

The speaker 220 outputs, for example, a guidance for a setting screen or a navigation screen to be displayed on the touch panel 222, by a voice. The microphone 221 receives the voice of a user. The input voice data can also be used in, for example, the authentication of a passenger. The touch panel 222 is a capacitive touch panel capable of detecting a change in capacitance between the touch panel 222 and a conductive object, such as a finger, approaching the touch panel 222, and capable of specifying the position of the finger by detecting the change. The touch panel 222 can be either a surface capacitive type or a projected capacitive type. The operation accepting unit 223 can accept an operation from the user by, for example, a power switch, an LED, and hardware keys.

The ECU 230 is a unit to be mounted in a control device for implementing driving control of the vehicle 100. This driving control includes control in which the vehicle system is a main driving party, and control in which the driver is a main driving party. The ECU 230 identifies a user by obtaining image data of a passenger captured by a camera 231 installed in the cabin of the vehicle 100. The ECU 230 can also identify the user by using not only the camera 231 but also detection information from a sensor 232 such as a pressure sensor mounted on a seat.

The ECU 230 can communicate with the external server 250 across a wireless communication network (not shown) by using an OF 233. The server 250 includes a CPU 251, a ROM 252, a RAM 253, and a storage unit 254. The CPU 251 comprehensively controls the server 250 by loading a program stored in the ROM 252 into the RAM 253, and executing the program. The storage unit 254 stores information for identifying a passenger of the vehicle 100. The CPU 251 can identify the passenger based on, for example, voice data, image data, and sensor's detection information transmitted from the vehicle 100.

The display apparatus 110 is connected to devices 240 so that they can communicate with each other. The devices 240 include an air-conditioner 241, an illuminator 242, an audio component 243, and a radio 244 installed in the cabin of the vehicle 100. The display apparatus 110 transmits setting information set on the setting screen displayed on the touch panel 222, for example, volume information of the audio component 243, to each device of the devices 240. Based on the transmitted setting information, each device controls its operation.

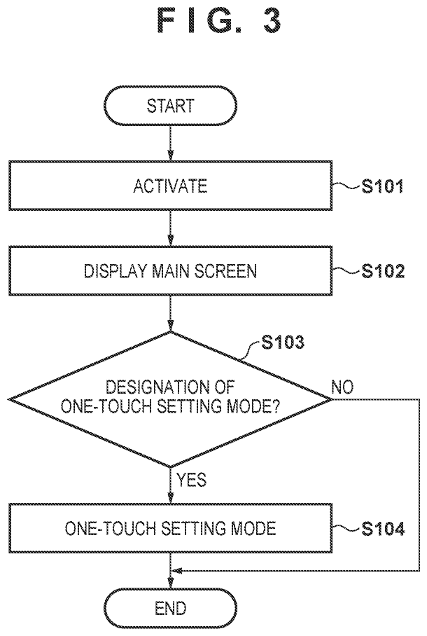

FIG. 3 is a flowchart showing a process of shifting to a one-touch setting mode. This process shown in FIG. 3 is started when the power supply of the display apparatus 110 is turned on. In step S101, the CPU 201 activates the display apparatus 110 by initializing each unit. In step S102, the CPU 201 displays a main screen on the touch panel 222. In step S103, the CPU 201 determines whether designation of the one-touch setting mode to be explained in this embodiment is accepted.

The one-touch setting mode will be explained below with reference to FIGS. 8, 9, and 10. FIG. 8 is a view showing the way a finger 804 of the user approaches the surface of the touch panel 222. Generally, a capacitive touch panel can specify the position of a finger on the touch panel even before the finger comes in contact with the screen. That is, as shown in FIG. 8, even when the finger 804 is not in contact with the display surface of the touch panel 222 and exists in any of regions 801, 802, and 803 during the course of a touch operation, the position of the finger 804 on the XY plane can be specified. In this embodiment based on a feature like this, screens to be displayed on the touch panel 222 change as the finger 804 approaches the touch panel 222 as indicated by arrows.

In this embodiment as shown in FIG. 8, the regions 801, 802, and 803 are determined as regions for detecting the finger 804. The X and Y directions of the regions 801, 802, and 803 respectively correspond to the longitudinal and lateral lengths of the touch panel 222. On the other hand, the distance of each of the regions 801, 802, and 803 in the Z direction corresponds to a predetermined capacitance range.

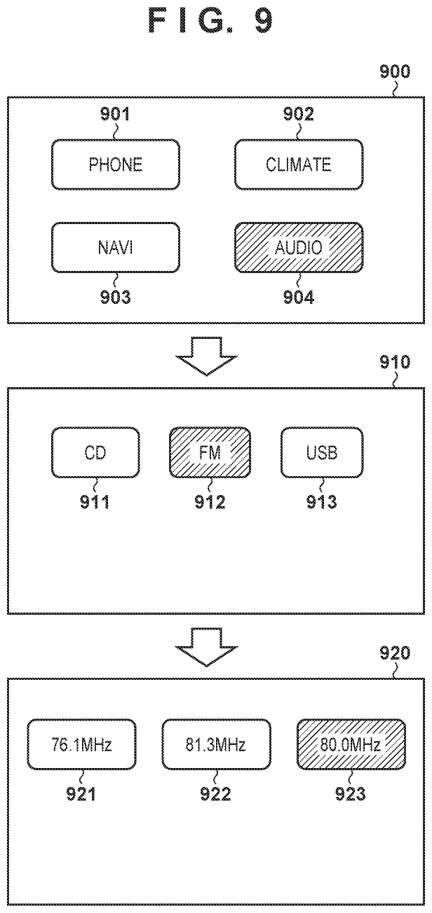

FIG. 9 is a view showing an example of transition of setting screens to be displayed on the touch panel 222. For example, a screen 900 displays selection items 901, 902, 903, and 904 for selecting functions. The screen 900 changes to a setting screen for a telephone function when the selection item 901 is selected, and changes to a setting screen for a cabin temperature adjusting junction when the selection item 902 is selected. Likewise, the screen 900 changes to a setting screen for a navigation function when the selection item 903 is selected, and changes to a setting screen for an audio function when the selection item 904 is selected.

The screen 900 shows a state in which the selection item 904 is selected. In this case, the screen 900 changes to a screen 910. The screen 910 displays selection items 911, 912, and 913 for selecting devices. The screen 910 changes to a setting screen for a CD when the selection item 911 is selected, changes to a setting screen for a radio when the selection item 912 is selected, and changes to a setting screen for a USB when the selection item 913 is selected.

The screen 910 shows a state in which the selection item 912 is selected. In this case, the screen 910 changes to a screen 920. The screen 920 displays selection items 921, 922, and 923 for selecting stations. For example, when the selection item 923 is selected, a radio 244 outputs the radio broadcasting of an 80.0-MHz station.

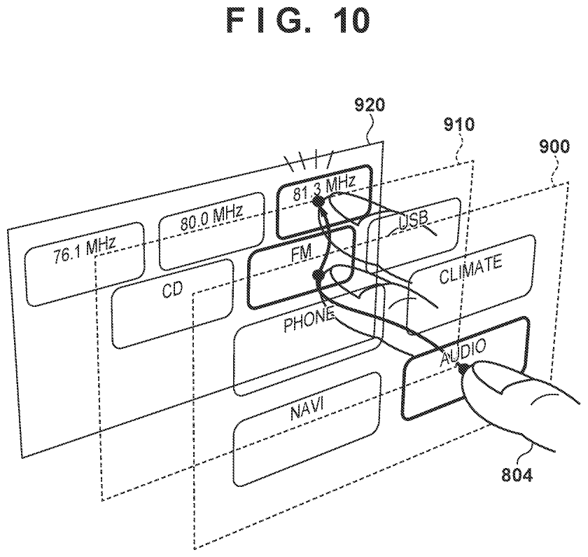

FIG. 10 is a view showing the way the screens change as the finger 804 approaches. For the sake of descriptive simplicity, FIG. 10 shows the screens 900, 910, and 920 as they are shifted from each other. However, all of these screens are originally displayed on the touch panel 222. Referring to FIG. 10, the position of the screen 920 is equivalent to the position of the surface of the touch panel 222, and the finger 804 approaches the surface by passing through the space as indicated by an arrow.

First, when the finger 804 reaches the region 801 shown in FIG. 8, the touch panel 222 displays the screen 900. The screen 900 is kept displayed while the finger 804 exists in the region 801.

Assume that the user selects the selection item 904 on the screen 900. In this case, the user moves the finger 804 to the position of the selection item 904 on the XY plane, and further moves the finger 804 closer to the touch panel 222 (Z-direction movement). When the finger 804 reaches the region 802 as shown in FIG. 8, the touch panel 222 displays the screen 910. The screen 910 is kept displayed while the finger 804 exists in the region 802.

Assume that the user selects the selection item 912 on the screen 910. In this case, the user moves the finger 804 to the position of the selection item 912 on the XY plane, and further moves the finger 804 closer to the touch panel 222 (Z-direction movement). When the finger 804 reaches the region 803 as shown in FIG. 8, the touch panel 222 displays the screen 920. The screen 920 is kept displayed while the finger 804 exists in the region 803. Assume that the user selects the selection item 923 on the screen 920. In this case, the user brings the finger 804 into contact with the selection item 923 on the touch panel 222.

The selection items 904, 912, and 923 are selected by the locus of the series of movements of the finger 804 described above. The arrow shown in FIG. 10 represents the locus of the finger 804 described above. In this embodiment as described above, the user need not perform any specific operation for determining selection on each screen, and hence can perform setting by a simpler operation on the setting screen having a plurality of layers. In this embodiment, the mode of performing setting by the series of movements of the finger 804 as described above is called “the one-touch setting mode”.

Referring to FIG. 3 again, the one-touch setting mode is not set on the main screen displayed in step S102. On this main screen, if a function setting menu requiring transition to the screen 900 is selected on the touch panel 222, it is determined in step S103 that designation of the one-touch setting mode is accepted. In this case, in step S104, the CPU 201 sets the touch panel 222 to operate in the one-touch setting mode. After that, the CPU 201 terminates the process shown in FIG. 3. On the other hand, if it is determined in step S103 that designation of the one-touch setting mode is not accepted, the CPU 201 immediately terminates the process shown in FIG. 3.

In the above description, the determination in step S103 is explained by taking, as an example, whether the menu for the one-touch setting mode is selected. However, it is also possible to display a button such as “Execute one-touch setting mode” on the main screen, and, if this button is selected, determine in step S103 that designation of the one-touch setting mode is accepted.

In the above explanation, the one-touch setting mode is not set on the main screen displayed in step S102. This can also be implemented by imposing the limitation that the position of the finger 804 on the XY plane can be specified when the surface of the touch panel 222 and the finger 804 are in contact with each other, that is, when the capacitance between the surface and the finger 804 becomes larger than a threshold. In addition, the CPU 201 can also cancel this limitation in step S104.

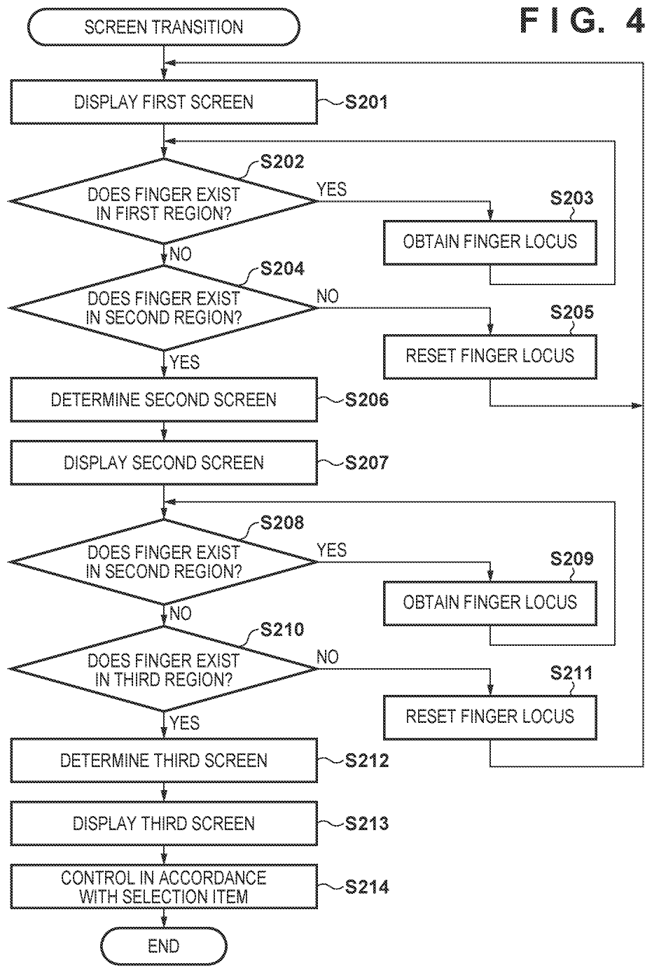

FIG. 4 is a flowchart showing the screen transition process corresponding to the approach of the finger 804. This process shown in FIG. 4 is started when the finger 804 approaches the touch panel 222 and reaches the region 801 shown in FIG. 8. In step S201, the CPU 201 displays a first screen on the touch panel 222. The first screen is, for example, the screen 900 shown in FIG. 9.

In step S202, the CPU 201 determines whether the finger 804 exists in a first region, that is, the region 801. If it is determined that the finger 804 exists in the region 801, the process advances to step S203, and the CPU 201 obtains locus information of the finger 804 and stores the information in the ROM 202. In this step, the CPU 201 displays a pointer on the screen 900 so that the pointer corresponds to the position of the finger 804 on the XY plane. With a configuration like this, the user can easily recognize the position pointed on the touch panel 222 by the finger 804, even when the finger 804 is apart from the touch panel 222.

The processing in step S202 is repeated after step S203. On the other hand, if it is determined in step S202 that the finger 804 does not exist in the region 801, the process advances to step S204. In step S204, the CPU 201 determines whether the finger 804 exists in a second region, that is, the region 802. If it is determined that the finger 804 does not exist in the region 802, the process advances to step S205, and the CPU 201 resets the locus information stored in the ROM 202. Since this is a case in which the finger 804 moves away from the region 801, the processing in step S201 is executed when the finger 804 reaches the region 801 again. On the other hand, if it is determined in step S204 that the finger 804 exists in the region 802, the process advances to step S206.

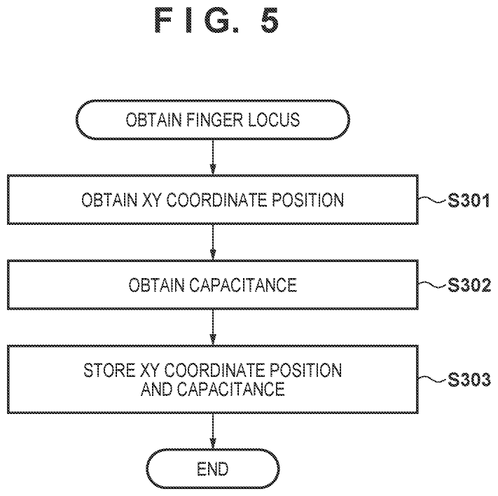

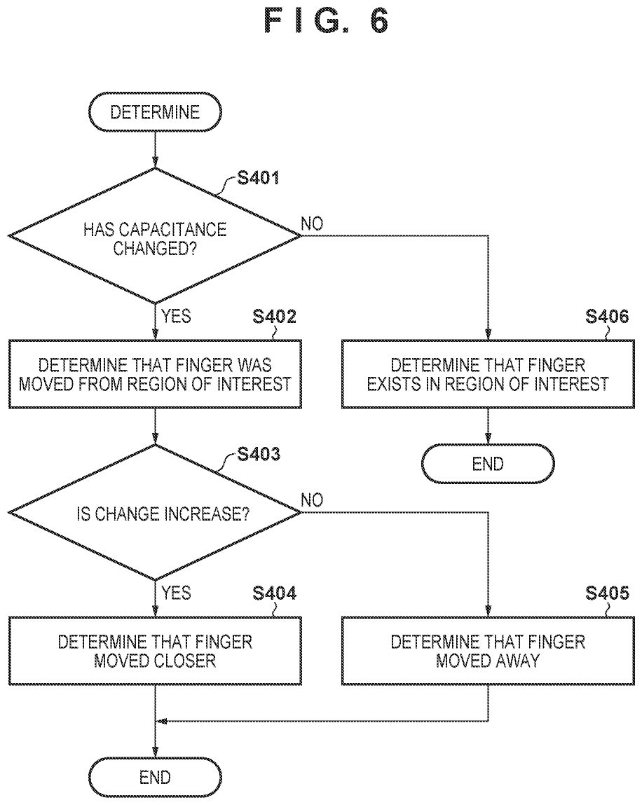

Details of the procedures in steps S202, S203, and S204 will be explained below with reference to FIGS. 5 and 6.

The process shown in FIG. 6 is executed when starting the processing in step S202 after the touch panel 222 displays the first screen in step S201. In step S401, the CPU 201 determines whether the capacitance has changed in accordance with the change in position of the finger 804 on the XY plane. If the capacitance falls within a predetermined range, the CPU 201 determines that the capacitance has not changed. Then, in step S406, the CPU 201 determines that the finger 804 exists in the region 801, and terminates the process shown in FIG. 6. This is equivalent to the case in which it is determined in step S202 of FIG. 4 that the finger 804 exists in the region 801. On the other hand, if the capacitance falls outside the predetermined range, the CPU 201 determines that the capacitance has changed. Then, in step S402, the CPU 201 determines that the finger 804 has moved from the region 801. After that, the process advances to step S403.

In step S403, the CPU 201 determines whether the change in capacitance in step S401 is an increase. If it is determined that the change in capacitance is an increase, the process advances to step S404, and the CPU 201 determines that the finger 804 has moved closer to the touch panel 222, and terminates the process shown in FIG. 6. This is equivalent to the case in which it is determined in step S204 of FIG. 4 that the finger 804 exists in the region 802. On the other hand, if it is determined that the change in capacitance is not an increase but a decrease, the process advances to step S405, and the CPU 201 determines that the finger 804 has moved away from the touch panel 222, and terminates the process shown in FIG. 6. This is equivalent to the case in which it is determined in step S204 of FIG. 4 that the finger 804 does not exist in the region 802.

The process shown in FIG. 5 is executed when it is determined in step S202 that the finger 804 exists in the region 801 and the processing in step S203 is started. In step S301, the CPU 201 obtains the coordinate position on the XY plane. In step S302, the CPU 201 obtains the capacitance in the coordinate position obtained in step S301. In step S303, the CPU 201 stores, in the ROM 202, the coordinate position obtained in step S301 and the capacitance obtained in step S302, by associating them with each other, and terminates the process shown in FIG. 5.

Referring to FIG. 4 again, if it is determined in step S204 that the finger 804 exists in the region 802, the process advances to step S206. The CPU 201 determines a second screen in step S206, and displays the second screen in step S207. The second screen is, for example, the screen 910 shown in FIG. 9.

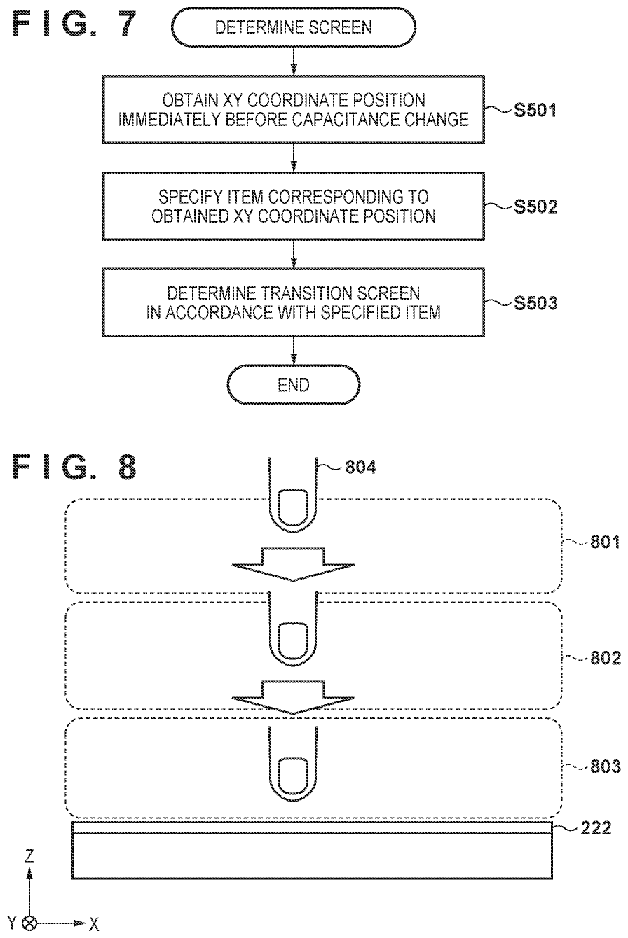

The processing in step S206 will be explained with reference to FIG. 7. In step S501, the CPU 201 obtains the coordinate position of the finger 804 on the XY plane immediately before it is determined in step S401 that the capacitance has changed. In step S502, the CPU 201 specifies a setting item on the screen, which corresponds to the coordinate position obtained in step S501. This is equivalent to, for example, specifying that the finger 804 is in the position of the selection item 904 before the screen 910 is displayed in FIG. 10.

In step S503, the CPU 201 determines a transition destination screen in accordance with the specified item. For example, if the selection item 904 on the screen 900 is selected, the CPU 201 determines that the screen 910 is a transition destination screen. After that, the CPU terminates the process shown in FIG. 7.

In step S208, the CPU 201 determines whether the finger 804 exists in the second region, that is, the region 802. If it is determined that the finger 804 exists in the region 802, the process advances to step S209, and the CPU 201 obtains locus information of the finger 804 on the XY plane and stores the information in the ROM 202. In this step, the CPU 201 displays a pointer on the screen 910 so that the pointer corresponds to the position of the finger 804 on the XY plane. A configuration like this enables the user to easily recognize the position pointed on the touch panel 222 by the finger 804, even when the finger 804 is apart from the touch panel 222.

After step S209, the CPU 201 repeats the processing in step S208. On the other hand, if it is determined in step S208 that the finger 804 does not exist in the region 802, the process advances to step S210. In step S210, the CPU 201 determines whether the finger 804 exists in a third region, that is, the region 803. If it is determined that the finger 804 does not exist in the region 803, the process advances to step S211, and the CPU 201 resets the locus information stored in the ROM 202. Since the finger 804 has moved away toward the region 801 in this case, the CPU 201 re-executes the processing in step S201. On the other hand, if it is determined in step S210 that the finger 804 exists in the region 803, the process advances to step S212.

Details of the procedures in steps S208, S209, and S210 will be explained below with reference to FIGS. 5 and 6.

The process shown in FIG. 6 is executed when starting the processing in step S208 after the touch panel 222 displays the second screen in step S207. In step S401, the CPU 201 determines whether the capacitance has changed in accordance with the change in position of the finger 804 on the XY plane. If the capacitance falls within the predetermined range, the CPU 201 determines that the capacitance has not changed. Then, in step S406, the CPU 201 determines that the finger 804 exists in the region 802, and terminates the process shown in FIG. 6. This is equivalent to the case in which it is determined in step S208 of FIG. 4 that the finger 804 exists in the region 802. On the other hand, if the capacitance falls outside the predetermined range, the CPU 201 determines that the capacitance has changed. Then, in step S402, the CPU 201 determines that the finger 804 has moved from the region 802. After that, the process advances to step S403.

In step S403, the CPU 201 determines whether the change in capacitance in step S401 is an increase. If it is determined that the change in capacitance is an increase, the process advances to step S404, and the CPU 201 determines that the finger 804 has moved closer to the touch panel 222, and terminates the process shown in FIG. 6. This is equivalent to the case in which it is determined in step S210 of FIG. 4 that the finger 804 exists in the region 803. On the other hand, if it is determined that the change in capacitance is not an increase but a decrease, the process advances to step S405, and the CPU 201 determines that the finger 804 has moved away from the touch panel 222, and terminates the process shown in FIG. 6. This is equivalent to the case in which it is determined in step S210 of FIG. 4 that the finger 804 does not exist in the region 803.

The process shown in FIG. 5 is executed when it is determined in step S208 that the finger 804 exists in the region 802, and the processing in step S209 is started. In step S301, the CPU 201 obtains the coordinate position on the XY plane. In step S302, the CPU 201 obtains the capacitance in the coordinate position obtained in step S301. In step S303, the CPU 201 stores, in the ROM 202, the coordinate position obtained in step S301 and the capacitance obtained in step S302, by associating them with each other, and terminates the process shown in FIG. 5.

Referring to FIG. 4 again, if it is determined in step S210 that the finger 804 exists in the region 803, the process advances to step S212. The CPU 201 determines a third screen in step S212, and displays the third screen in step S213. The third screen is, for example, the screen 920 shown in FIG. 9.

The processing in step S212 will be explained with reference to FIG. 7. In step S501, the CPU 201 obtains the coordinate position of the finger 804 on the XY plane immediately before it is determined in step S401 that the capacitance has changed. In step S502, the CPU 201 specifies a setting item on the screen, which corresponds to the coordinate position obtained in step S501. This is equivalent to, for example, specifying that the finger 804 is in the position of the selection item 912 before the screen 920 is displayed in FIG. 10.

In step S503, the CPU 201 determines a transition destination screen in accordance with the specified item. For example, if the selection item 912 on the screen 910 is selected, the CPU 201 determines that the screen 920 is a transition destination screen. After that, the CPU terminates the process shown in FIG. 7.

In step S214, the CPU 201 controls the devices 240 based on a combination of the selection items selected as the finger 804 approaches the touch panel 222. Since the items 904, 912, and 923 are selected in the examples shown in FIGS. 9 and 10, the CPU 201 transmits setting information to the radio 244 so as to select the 80.0-MHz station. In this embodiment as described above, while the user is moving the finger 804 closer to the touch panel 222, the user selects selection items, and the screens are changed in accordance with the selections. This can further simplify the user operation.

In the above explanation, the devices 240 are controlled in step S214 based on the combination of the selection items having been selected. In this step, it is also possible to associate the selection item combination with user identification information, and store the result as the operation log information 212 in the storage unit 210. The user identification information in this case is information obtained when the ECU 230 identifies the user when he or she gets in the vehicle 100, based on a feature amount obtained from the camera 231 or the sensor 232. Alternatively, the ECU 230 transmits the feature amount obtained by the camera 231 or the sensor 232 to an external server (not shown), and the server identifies the user based on the feature amount and transmits the user identification information to the ECU 230.

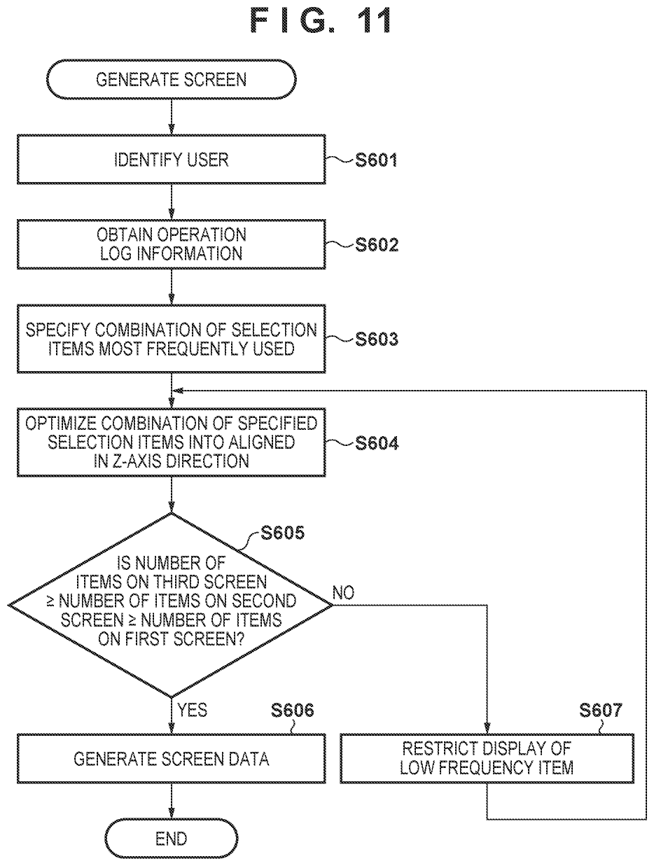

A process of generating screen data to be displayed on the touch panel 222 based on a combination of selection items frequently used by the user will be explained below with reference to FIG. 11. This process shown in FIG. 11 is executed when the user gets in the vehicle 100.

In step S601, the CPU 201 identifies the user. The CPU 201 may also obtain the user identification information obtained by the ECU 230 as described above. In step S602, the CPU 201 obtains the operation log information 212 corresponding to the user identified in step S601 from the storage unit 210. Then, in step S603, the CPU 201 specifies a combination of selection items most frequently used by the user from the obtained operation log information 212. For example, the CPU 201 specifies a combination of selection items such as “Audio, CD, Random playback” as the operation log information 212 corresponding to user A.

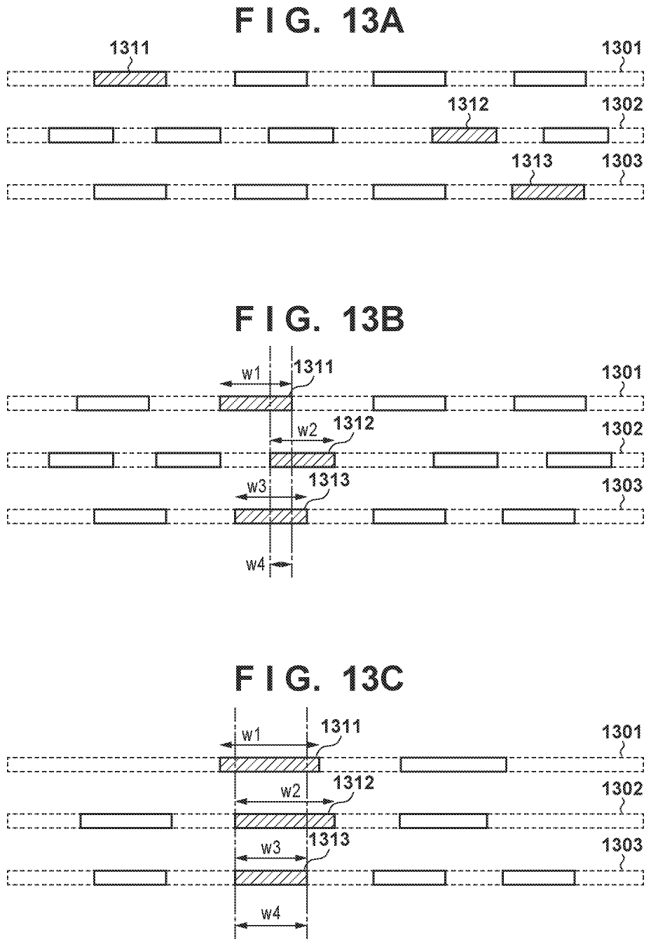

In step S604, the CPU 201 performs optimization so that icons of the selection items specified in step S603 are aligned in the Z-axis direction, that is, so that the motion of the finger 804 in the XY-axis direction decreases when the finger 804 approaches the touch panel 222. This processing in step S604 will be explained below with reference to FIGS. 13A, 13B, and 13C.

Referring to FIGS. 13A, 13B, and 13C, a screen 1301 corresponds to the screen 900 shown in FIGS. 9 and 10, a screen 1302 corresponds to the screen 910 shown in FIGS. 9 and 10, and a screen 1303 corresponds to the screen 920 shown in FIGS. 9 and 10. In FIGS. 13A, 13B, and 13C, the vertical direction corresponds to the Z-axis direction shown in FIG. 8, the dotted lines represent the individual screens, and the solid lines represent the icons of the selection items. Selection items 1311 to 1313 are the selection items most frequently used by the user.

Assume that the selection items 1311, 1312, and 1313 respectively correspond to “Audio”, “CD”, and “Random playback”. FIG. 13A shows the default layout of the selection items on the screens 1301 to 1303.

As shown in FIG. 13A, the selection items 1311, 1312, and 1313 are scattered in the Z-axis direction. In this default layout, the CPU 201 first changes the positions of the selection items 1311 to 1313 so as to align the selection items 1311 to 1313 most in the Z-axis direction, that is, so as to minimize the motion of the finger 804 in the XY-axis directions when the finger 804 approaches the touch panel 222.

The process of aligning the selection items 1311 to 1313 most in the Z-axis direction will be explained. Let w1, w2, and w3 be the icon widths of the selection items 1311, 1312, and 1313, respectively. The process of aligning the selection items 1311 to 1313 most in the Z-axis direction is to adjust the positions of the individual icons so as to maximize a width w4 in which the icon widths w1, w2, and w3 overlap each other. In FIG. 13B, the selection items 1311 to 1313 are arranged in positions that maximize the width w4 in the default layout.

Referring to FIG. 11 again, in step S605, the CPU 201 determines whether the numbers of selection items on the individual screens satisfy a predetermined condition. In this step, it is determined whether the number of selection items on a third screen the number of selection items on a second screen the number of selection items on a first screen is satisfied. The first, second, and third screens are respectively the screens 1301, 1302, and 1303.

In the case of FIG. 13B, for example, the number of selection items on the first screen=4, the number of selection items on the second screen=5, and the number of selection items on the third screen=4, so the above-described condition is not satisfied. Therefore, the process advances to step S607. In step S607, the CPU 201 restricts the display of a selection item having a low use frequency on each screen so as to satisfy the abovementioned relation.

This processing in step S607 will be explained. In FIG. 13B, two selection items are specified in ascending order of use frequency on the screen 1301, and two selection items are specified in ascending order of use frequency on the screen 1302. That is, in principle, selection items having low use frequencies are specified so as to meet the number of selection items on a third screen the number of selection items on a second screen≥the number of selection items on a first screen. In the case of FIG. 13B, for example, 4≥3≥2 is obtained, that is, the abovementioned relation is met, by restricting the display by specifying selection items having low use frequencies as described above.

Subsequently, the CPU 201 adjusts the icon widths w1 to w3 of the selection items 1311 to 1313 so as to maximize the width w4. As shown in FIG. 13C, for example, the width w4 is made equal to the icon width w3 by increasing the icon widths w1 and w2. The range of the adjustment width of the selection items 1311 and 1312 can be increased by specifying selection items having low use frequencies so as to obtain 4≥3≥2 as described above.

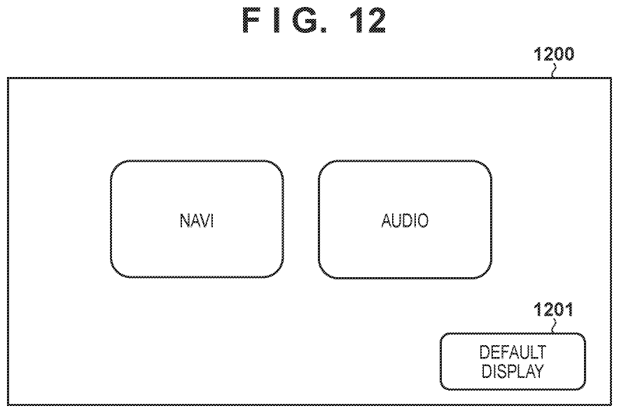

FIG. 12 is a view showing an example in which the display of selection items having low use frequencies is restricted in step S607. On the screen 1301 shown in FIGS. 13A, 13B, and 13C in which four selection items are arranged as a default layout, the processing in step S607 restricts the display of two selection items having low use frequencies. Consequently, only two selection items including a selection item having the highest use frequency are displayed. The two selection items on a screen 1200 are displayed by icons having a size larger than that of the selection items on the screen 900 shown in FIG. 9. By performing display control like this, this embodiment can minimize displacement in the XY-plane direction (that is, scattering on the display surface) when the finger 804 moves in the Z-axis direction. Also, the detection accuracy of the finger 804 decreases as the finger 804 moves away from the touch panel 222. In this display control, however, the number of selection items decreases and the icon size of the selection times increases as the finger 804 moves away from the touch panel 222. This can compensate for the decrease in detection accuracy of the finger 804.

In the abovementioned explanation, selection items having low use frequencies are specified on the screens 1301 and 1302 by performing the processing in step S607 once. However, this operation may also be performed by performing the processing in step S607 a plurality of times. That is, selection items having low use frequencies are first specified on the screen 1302 in step S607, and the process returns to step S604 after that. After step S605, selection items having low use frequencies are specified again on the screen 1301 in step S607.

If it is determined in step S605 that the number of selection items on each screen satisfies the predetermined condition, the process advances to step S606, and the CPU 201 generates screen data based on the optimized selection item layout. For example, the CPU 201 generates screen data indicating the screens 1301 to 1303 based on the layout of the selection items 1311 to 1313 shown in FIG. 13C.

After the screen data is generated in step S606, the touch panel 222 displays a screen such as the screen 1200 shown in FIG. 12, and also displays an icon 1201. The screen 900 shown in FIG. 9 can also be displayed when the user points the position of the icon 1201 with the finger 804 for a predetermined time. In this embodiment as described above, screen display is performed such that the number of selection items (the number of icons) on each screen satisfies the predetermined condition based on the user's operation log. However, it is also possible to perform presetting, regardless of the user's operation log, so that the number of selection items decreases and the icon size of the selection items increases as the finger 804 moves away from the touch panel 222. This operation can be implemented by, for example, the following processing. When the display apparatus 110 is activated in step S101 of FIG. 3, the CPU 201 obtains, from the storage unit 210, screen data of a plurality of layers to be displayed as default data on the touch panel 222. When displaying this screen data of a plurality of layers, the CPU 201 enables the user to specify an icon to be displayed and an icon not to be displayed for screen data of each layer. Specification like this can also be performed on a screen data icon editing screen to be displayed after the display apparatus 110 is activated. Also, when enabling the user to specify icons, the CPU 201 urges the user to satisfy a predetermined condition (for example, the number of icons decreases as the finger moves away from the touch panel 222) by a message or the like. When the user has specified icons for the screen data of each layer, the CPU 201 performs optimization so that the icons (or icon groups) to be displayed in the individual layers are aligned in the Z-axis direction. This optimization is the same as explained in step S604.

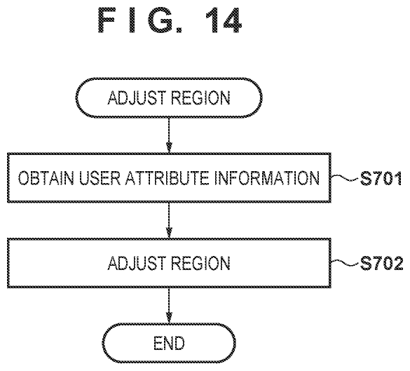

Next, a process of changing the ranges of the regions 801 to 803 shown in FIG. 8 in accordance with the attribute of the user will be explained. A capacitive touch panel detects the position of an approaching human body (finger) in accordance with the capacitance between the touch panel and the finger. Accordingly, the detection performance can vary in accordance with the state of the finger. For example, the detection performance changes in accordance with whether the humidity or the like of the finger is high or low. In other words, if the regions 801 to 803 are fixed, the finger may not accurately be detected depending on the state of the finger. The process of changing the ranges of the regions 801 to 803 in the Z-axis direction in accordance with the user attribute including the state of the finger will be explained below with reference to FIG. 14.

In step S701, the CPU 201 obtains user attribute information. For example, the CPU 201 obtains the user attribute information when obtaining the user identification information from the ECU 230. Examples of the user attribute information are the nationality, the height, the weight, and the degree of humidity of the finger. Information such as the nationality, the height, and the weight can be stored in the external server 250 by associating the information with the user identification information. In this case, when the server identifies the user by receiving information obtained by the camera 231 or the sensor 232 from the ECU 230, the server can transmit the user attribute information such as the nationality, the height, and the weight to the ECU 230 in addition to the user identification information. The degree of humidity of the finger may also be obtained based on, for example, information detected by the ECU 230 from a humidity sensor attached to the steering wheel.

The capacitance is largely affected by the degree of humidity and the size of the finger 804. Therefore, the user attribute information is not limited to the abovementioned information as long as these two elements are introduced.

In step S702, the CPU 201 adjusts the range of each of the regions 801 to 803 in the Z-axis direction based on the user attribute information obtained in step S701. For example, as the degree of humidity of the finger 804 increases, the CPU 201 decreases the range of each of the regions 801 to 803 in the Z-axis direction, because it can be expected that the detection performance improves. Likewise, as the size of the finger 804 increases, the CPU 201 decreases the range of each of the regions 801 to 803 in the Z-axis direction, because it can be expected that the detection performance improves. It is also possible to combine the two pieces of information. The size of the finger 804 can also be estimated from, for example, the height and the weight, or the nationality.

In the explanation of this embodiment, the position of the finger 804 in the Z-axis direction is detected based on the capacitance. However, the position of the finger 804 in the Z-axis direction may also be detected by another detection method. For example, it is also possible to form a detection plate including a plurality of electrode patterns for detecting the capacitance, such that the detection plate is perpendicular to the display surface of the touch panel 222 and positioned on the side of the touch panel 222. That is, the position of the finger 804 in the Z-axis direction is detected by not the electrodes of the touch panel 222 but the electrodes of the detection plate formed on the side of the touch panel 222. If the detection plate like this is so formed as to detect the position of the finger 804 in the Z-axis direction and the position of the finger 804 on the XY plane in accordance with the change in capacitance, a display unit that is not a capacitive touch panel may also be used instead of the touch panel 222. Furthermore, the abovementioned detection plate can also be configured not to detect the capacitance but to detect the position of the finger 804 in the air by using an infrared sensor or the like.

### Summary of Embodiment

A display apparatus of the abovementioned embodiment comprises a display unit (the touch panel 222) configured to display screen data containing a plurality of selectable items, and a display control unit configured to change the screen data in accordance with selection of an item contained in the screen data, when a touch operation is performed on a display surface of the display unit (FIG. 4), wherein during a course of the touch operation, the display control unit changes the screen data in accordance with a position in a space on the display surface, which corresponds to an item (steps S204, S206, S210, S212). Also, when the touch operation has passed the position of a conductive object in the space on the display surface, which corresponds to the item, the display control unit determines that the item is selected and changes the screen data.

In a configuration like this, when the position in the space, which corresponds to an item to be selected, is passed, the screen data can be changed by determining that the item is selected. This can further simplify the user operation.

The display unit is a capacitive touch panel (the touch panel 222, FIG. 8) capable of detecting a change in capacitance between the touch panel and the conductive object. A configuration like this can further simplify the user operation when displaying screen data on the capacitive touch panel.

The display apparatus further comprises a detection unit configured to detect a capacitance between the detection unit and the object (step S302), and a determination unit configured to determine whether the capacitance detected by the detection unit falls within a predetermined range (step S401), wherein after the determination unit determines that the capacitance falls within the predetermined range, if the determination result from the determination unit changes and indicates that the capacitance falls outside the predetermined range, the display control unit determines that the item is selected and changes the screen data (step S402). A configuration like this can change the screen data based on the change in capacitance.

The object is a finger, and the display apparatus further comprises a changing unit configured to change the predetermined range based on information about the finger (FIG. 14). The information about the finger contains one of humidity and a size of the finger. A configuration like this can change the predetermined range of the capacitance based on the humidity of the finger.

The display apparatus further comprises an obtaining unit configured to obtain the information about the finger (step S701). The display apparatus is mounted in a vehicle, and the obtaining unit obtains the information about the finger based on information about a passenger of the vehicle. A configuration like this can obtain, for example, the size of the finger based on the information about the passenger of the vehicle.

The number of items contained in screen data as a transition target of the display control unit is not more than the number of items contained in screen data as a transition destination (step S605). A configuration like this decreases the number of items as the finger moves away from the display surface of the touch panel. This can compensate for a decrease in detection accuracy.

The display control unit changes the screen data between a plurality of predetermined screen data. The display apparatus further comprises a determination unit configured to determine a layout of items contained in each of the plurality of screen data (FIG. 11). The display apparatus further comprises a storage unit (the storage unit 210) configured to store the selected item as log information, wherein the determination unit determines the layout of items contained in each of the plurality of screen data based on the log information. In addition, the determination unit determines the layout such that scattering of items contained in each of the plurality of screen data decreases on the display screen (FIGS. 13A, 13B, and 13C).

A configuration like this can lay out, for example, selection items having high use frequencies so as to decrease displacement on the XY plane.

The invention is not limited to the abovementioned embodiment and can variously be modified and changed without departing from the spirit and scope of the invention.

What is claimed is:

1. A display apparatus comprising:
a display unit configured to display screen data containing a plurality of selectable items; and
a display control unit configured to change the screen data in accordance with selection of an item contained in the screen data, when a touch operation is performed on a display surface of the display unit,
wherein during a course of the touch operation, the display control unit changes the screen data in accordance with a position of a conductive object in a space on the display surface, which corresponds to an item.

2. The apparatus according to claim 1, wherein when the touch operation has passed the position in the space on the display surface, which corresponds to the item, the display control unit determines that the item is selected and changes the screen data.

3. The apparatus according to claim 1, wherein the display unit is a capacitive touch panel capable of detecting a change in capacitance between the touch panel and the conductive object.

4. The apparatus according to claim 3, further comprising:
a detection unit configured to detect a capacitance between the detection unit and the object; and
a determination unit configured to determine whether the capacitance detected by the detection unit falls within a predetermined range,
wherein after the determination unit determines that the capacitance falls within the predetermined range, if the determination result from the determination unit changes and indicates that the capacitance falls outside the predetermined range, the display control unit determines that the item is selected and changes the screen data.

5. The apparatus according to claim 4, wherein
the object is a finger, and
the display apparatus further comprises a changing unit configured to change the predetermined range based on information about the finger.

6. The apparatus according to claim 5, wherein the information about the finger contains one of humidity and a size of the finger.

7. The apparatus according to claim 5, further comprising an obtaining unit configured to obtain the information about the finger.

8. The apparatus according to claim 7, wherein
the display apparatus is mounted in a vehicle, and
the obtaining unit obtains the information about the finger based on information about a passenger of the vehicle.

9. The apparatus according to claim 1, wherein the number of items contained in screen data as a transition target of the display control unit is not more than the number of items contained in screen data as a transition destination.

10. The apparatus according to claim 1, wherein the display control unit changes the screen data between a plurality of predetermined screen data.

11. The apparatus according to claim 10, further comprising a determination unit configured to determine a layout of items contained in each of the plurality of screen data.

12. The apparatus according to claim 11, further comprising a storage unit configured to store the selected item as log information,
wherein the determination unit determines the layout of items contained in each of the plurality of screen data based on the log information.

13. The apparatus according to claim 11, wherein the determination unit determines the layout such that scattering of items contained in each of the plurality of screen data decreases on the display screen.

14. A display control method to be executed in a display apparatus, comprising:
displaying screen data containing a plurality of selectable items on a display unit;
changing the screen data in accordance with selection of an item contained in the screen data, when a touch operation is performed on a display surface of the display unit, and
changing the screen data in accordance with a position of a conductive object in a space on the display surface, which corresponds to an item, during a course of the touch operation.

15. A non-transitory computer-readable storage medium storing a program for causing a computer to perform:
displaying screen data containing a plurality of selectable items on a display unit;
changing the screen data in accordance with selection of an item contained in the screen data, when a touch operation is performed on a display surface of the display unit, and
changing the screen data in accordance with a position of a conductive object in a space on the display surface, which corresponds to an item, during a course of the touch operation.
